(19) United States
(12) Patent Application Publication
(10) Pub. No.: US 2007/0214113 A1
(43) Pub. Date: Sep. 13, 2007

(54) Method to support multiple data sources connecting to a persistent object

(76) Inventors: Yang Lei, Cary, NC (US); Hasan Muhammad, Raleigh, NC (US); Jian Tang, Rochester, MN (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/374,574

(22) Filed: Mar. 13, 2006

(51) Int. Cl. G06F 17/30

(52) U.S. Cl. 707/3

(57) ABSTRACT

The EJB multiple data source connector is a computer implemented process for connecting an EJB CMP bean to multiple data sources, the computer implemented process comprising the following steps. The EJB multiple data source connector binds the EJB bean to the JNDI name of multiple data sources in a mapping file. The EJB multiple data source connector receives a data query from an application and connects to a data source listed in the mapping file. The EJB multiple data source connector issues the query to the connected data source. After receiving a response from the connected data source, the EJB multiple data source connector saves the response in a results file. The EJB multiple data source connector repeats the steps of connecting to a data sources, issuing a query, receiving a response and saving the response for every data source listed in the mapping file then returns the results to the application.

### FIELD OF THE INVENTION

The invention is related generally to data processing apparatus and corresponding methods for the retrieval of data stored in a database, and more particularly to the remote retrieval of data stored in multiple databases through a persistent data object.

### BACKGROUND OF THE INVENTION

In recent years, traditional two-tier client/server systems have been displaced slowly by more sophisticated multi-tier client/server systems. In general, a multi-tier system places at least one intermediate component between the client and the server. These components are referred to commonly as “middleware.” Generalized “n-tier” systems include n layers of software that provide a different layer of services at varying levels of detail to the layers above and beneath them, where n is any number. See Mark Johnson, A beginner's guide to Enterprise JavaBeans, JavaWorld, at http://www.javaworld.com (October 1998), incorporated herein by reference. Programmers often use multiple client/server tiers in enterprise software applications to separate and delegate the programming tasks. In particular, one tier usually includes objects that implement the business operations while one or more other tiers provide objects that implement the underlying data processing (such as creating a data structure to represent the cart or saving the consumer's order to a database).

“Object-oriented” languages and techniques also have become increasingly popular in recent years. In general, an “object” is a named memory unit that contains data and instructions for manipulating that data. In an object-oriented context, the terms “attribute” and “property” are often synonymous and generally refer to the data within the memory unit, and the term “method” or “procedure” refers to the related instructions for manipulating the data. In practice, objects often include methods that direct the process of storing the object's attributes within a file or database. Of course, an object that includes such a method also generally includes one or more methods that direct other types of operations, such as retrieving, updating, or removing attributes from the file or database.

Today, computer programmers frequently implement enterprise applications with a mix of n-tiered architectures and object-oriented technology. Sun Microsystems, Inc. (SUN) has developed a comprehensive collection of objects and other supporting programs that programmers can use to build sophisticated enterprise applications. SUN currently markets this collection as the JAVA 2 ENTERPRISE EDITION (J2EE) platform. SUN also has developed an application program interface (API) for J2EE that defines an n-tiered architecture, which SUN currently markets as the ENTERPRISE JAVABEANS (EJB) architecture.

FIG. 1 depicts a typical EJB system architecture. Generally, an EJB architecture comprises EJB server 120, EJB container 130, EJB components 132 and 134 (also commonly known as a “bean), an EJB object (referred to here as EJB Object 110), and a database 140. Typical EJB subsystems comprise one or more objects that implement the functions of the interface. Thus, the term “EJB client” will be used herein, instead of the term “EJB object,” to avoid any confusion with a generic “object.” An EJB component, which typically implements business operations, executes within an EJB container. EJB components also must have a “home interface” through which an EJB client can create, initialize, remove, and find a specific instance of an EJB component. The methods that a home interface implements to find a specific instance of an EJB component and retrieve data are known as “finder” methods. The EJB container, which implements many of the data processing operations, executes within an EJB server. The EJB server generally executes within any given computer's native environment. An EJB client, though, allows client programs to execute the EJB component, through the EJB component's EJB container.

An “entity bean” is one type of EJB component used to model data in enterprise applications, the attributes of which are typically persisted within a database. The term “persist” generally refers to the process of storing, updating, and deleting such attributes to or from a database. An entity bean may manage the persistence of its attributes (commonly known as “bean managed persistence” or “BMP”), or it may delegate the responsibility to the EJB container in which it executes (commonly known as “container managed persistence” or “CMP”). CMP often is favored by programmers since many routine persistence tasks are handled by the EJB container and relieves the programmer from writing persistence code. BMP provides greater flexibility, but at the expense of increased burden on the programmer.

Currently, EJB CMP beans can connect to one data source only. Many enterprise applications, though, need to access data stored in multiple databases or partitions within a database. For example, many enterprises have multiple office locations, and each office location has a separate database. Alternatively, some enterprise applications need to access multiple databases for reporting and statistical analyses.

Consequently, a conventional J2EE application requires a separate CMP bean to be deployed for each database accessed by the application. Clearly, this requirement necessitates additional installation time, storage, maintenance, and memory. One known solution to connecting a single CMP bean to multiple data sources is described in U.S. Pat. No. 6,901,409. The '409 patent discloses using a “proxy” database which connects to other data sources. The proxy database must be able to integrate the data from every database, so that it appears as a single virtual database. This solution requires sophisticated software that is compatible with each database to be accessed. Essentially, the method of the '409 patent still only connects the CMP bean to a single data source, the proxy database. Additional software performs queries to the other data sources.

A need exists for a method for connecting an application directly to multiple data sources using from single EJB CMP bean.

### SUMMARY OF THE INVENTION

The EJB multiple data source connector meets the need identified above. The EJB multiple data source connector is a computer implemented process for connecting an EJB CMP bean to multiple data sources, the computer implemented process comprising the following steps. The EJB multiple data source connector receives a data query and connects to a data source. The EJB multiple data source connector issues the query to the connected data source. After receiving a response as and EJB object from the connected data source, the EJB multiple data source connector binds the EJB object to the data source. The EJB multiple data source connector repeats the steps of connecting to a data source, issuing a query, receiving a response as an EJB object and binding the EJB object to the data source. The EJB multiple data source connector then returns the results to the query initiator.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 represents a typical EJB system architecture (prior art).

FIG. 2 represents an exemplary computer network.

FIG. 3 describes programs and files in memory on a computer.

FIG. 4 is a flow chart of the Find Component.

FIG. 5 is a flow chart of the Create Component.

FIG. 6 is a flow chart of the Update Component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “EJB Multiple Data Source Connector”.

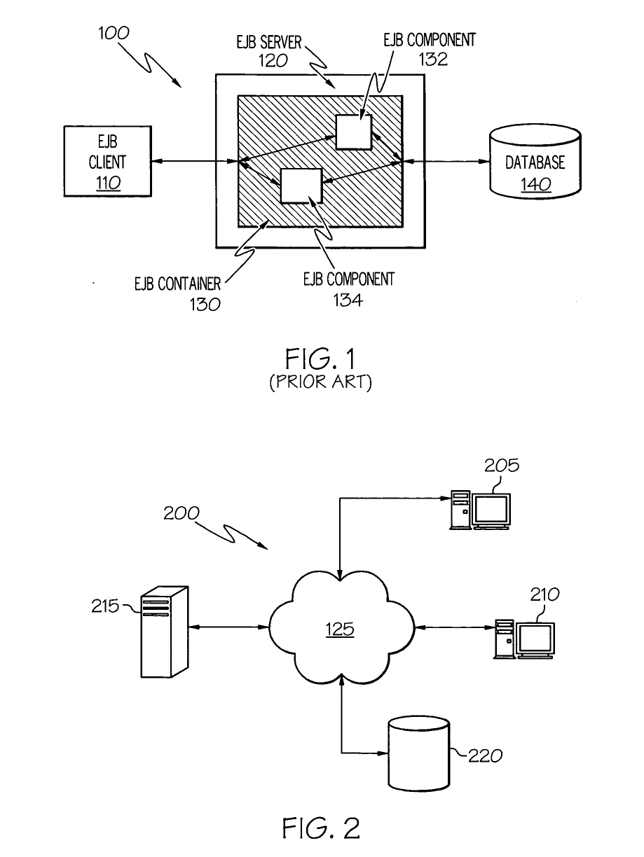

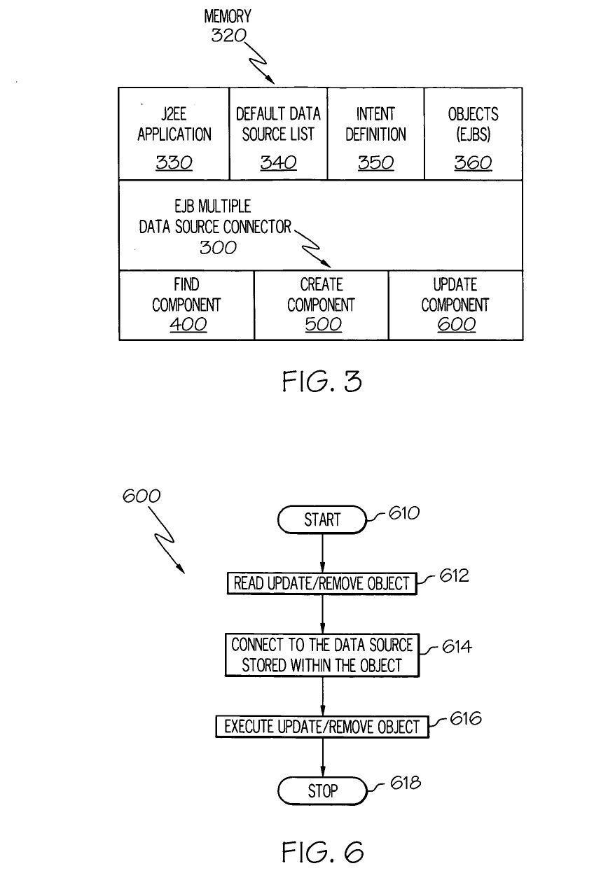

Additionally, the “EJB Multiple Data Source Connector” is described below with reference to an exemplary network of hardware devices, as depicted in FIG. 2. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 200 has only a limited number of nodes, including workstation computer 205, workstation computer 210, server computer 215, and persistent storage 220. Network connection 225 comprises all hardware, software, and communications media necessary to enable communication between network nodes 205-220. Unless otherwise indicated in context below, all network nodes use publicly available protocols or messaging services to communicate with each other through network connection 225.

EJB Multiple Data Source Connector 300 typically is stored in a memory, represented schematically as memory 320 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 320. As depicted in FIG. 2, though, memory 320 may include additional data and programs. Of particular import to EJB Multiple Data Source Connector 300, memory 320 may include J2EE Application 330, Default Data Source List 340, Intent Definition 350 with which EJB Multiple Data Source Connector 300 interacts. Various Objects (EJBS) 360 also reside in Memory 320.

J2EE application 330 is an application running in Memory 320 that requires information stored in multiple data sources. Default Data Source List 340 contains the JNDI identifier for each available data source. Data Source List 340 can be used by either J2EE Application 330 or EJB Multiple Data Source Connector 300 to locate information. Intent Definition 350 contains a query for information from J2EE Application 330 and the target data sources containing the desired information. Objects (EJBS) 360 are ENTERPRISE JAVABEANS which are named memory units that contain data and instructions for manipulating that data using a J2EE platform.

EJB Multiple Data Source Connector 300 operates in three different scenarios, each scenario are described here as components: Find Component 400, Create Component 500 and Update Component 500. Find Component 400 intercepts queries from J2EE application 330, and sends the query to each target data source in succession via the same EJB CMP bean, then returns all the responses from each data source at once to J2EE Application 330. Create Component 500 associates (binds) Objects (EJBS) 360 to various data sources. Update Component 600 updates or removes bindings between Objects (EJBS) 360 and various data sources.

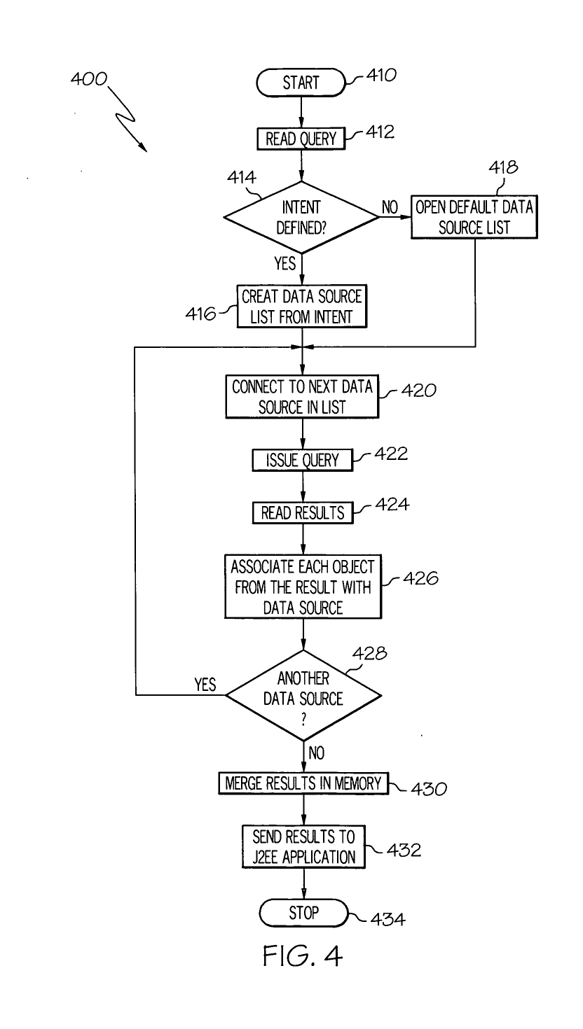

FIG. 4 is a flowchart of Find Component 400. Find Component 400 starts whenever J2EE Application 330 performs a data query (410). Find Component 400 reads the data query (412) and determines if the intent is defined (414). J2EE Application 330 can set the intent for a query with a list of the intended data source JNDI names before executing a query. This can be achieved either by defining a static XML file relating to the query or setting the intent as part of the application's runtime program. The XML intent file is represented here as by Intent Definition 350. If the intent is defined, Find Component 400 creates a data source list from Intent Definition 350 (416), otherwise, Find Component 400 opens Default Data Source List 340 (418). Find Component 400 iteratively connects to the next data source listed in the data source list (420) and issues the original query from J2EE Application 330 (422). The query results from the data source, which are returned as an EJB object, are read (526) and Find Component 400 associates (binds) the EJB object from the results to the JNDI name of the data source (528). If there is another data source listed in the data source list (428), Find Component 400 repeats the steps of connecting to the data source (420), issuing the query (422), reading the results (424) and binding the EJB object in the results to the data source (430). Once all data sources have been queried, Find Component 400 merges all the results in memory and sends the results to J2EE Application 330 (432) and stops (434).

By using the JNDI name to bind the EJB object to the data source, the association becomes independent of database schema or vendor. Thus, EJB Multiple Data Source Connector 300 allows J2EE Application 330 to perform in a single query what would have required multiple queries under the prior art Further, a single EJB object can be associated to multiple data sources by Find Component 400, with one data source being the default binding. This overcomes the limitation from the prior art that an EJB object can only have bindings to a single data source.

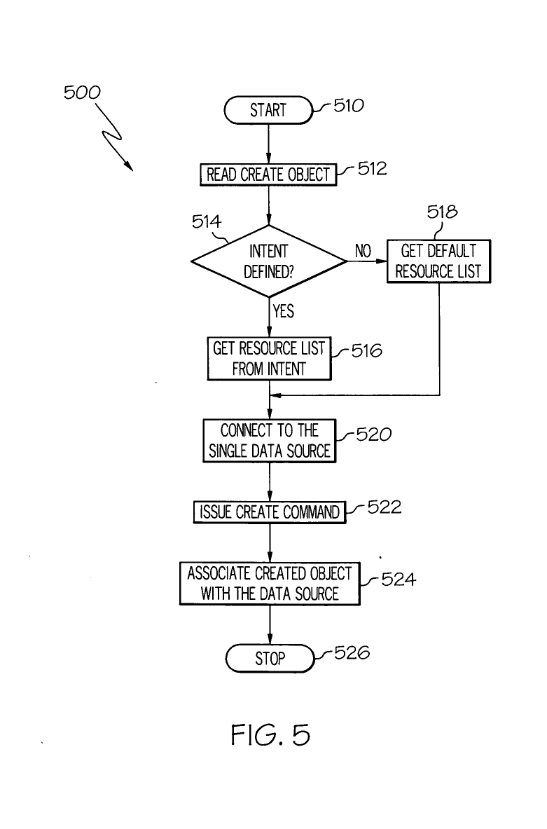

FIG. 5 is a flowchart of Create Component 500. Create Component 500 starts whenever a create object command is issued by J2EE Application 330 or a user (510). Create Component 500 reads the create object command (512) and determines if the intent is defined by Intent Definition 350 (514). If the intent is defined, Create Component 500 creates a data source list from Intent Definition 350 (516), otherwise, Create Component 500 opens Default Data Source List 340 (518). Create Component 500 connects to the single defined data source (520) and issues the create command to create the EJB object (522). Create Component 500 associates (binds) the newly created EJB object to the JNDI name of the data source (524) and stops (526).

FIG. 6 is a flowchart of Update Component 600. Update Component 600 starts whenever an object update or object remove command is issued by J2EE Application 330 or a user (610). Update Component 600 reads the update or remove command (612), connects to the data source stored within the EJB object (614). Update Component 600 executes the update or remove command (616) which has the effect of updating or removing the association (binding) between the EJB object and the JNDI name of the data source, then stops (618).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for connecting an EJB CMP bean to multiple data sources, the computer implemented process comprising:
receiving a data query;
connecting to a data source;
issuing the query to the connected data source;
receiving a response as an EJB object from the connected data source;
binding the response EJB object to the JNDI name of the data source;
repeating the steps of issuing the query, receiving the response EJB object and binding the response EJB object for another data source; and
returning the results to the query initiator.

2. The computer implemented process of claim 1 wherein the data query comes from an application running on a J2EE computer platform.

3. The computer implemented process of claim 2 wherein the query and target data sources are listed in an XML intent file created by the application.

4. The computer implemented process of claim 1 wherein the data sources are listed in a default data source file.

5. The computer implemented process of claim 1 wherein the request is to create a new EJB object.

6. The computer implemented process of claim 1 wherein the request is to update the binding between an existing EJB object and a data source.

7. The computer implemented process of claim 1 wherein the request is to delete the binding between an existing EJB object and a data source.

8. An apparatus for connecting an EJB CMP bean to multiple data sources, the apparatus comprising:
a processor;
a memory connected to the processor;
a J2EE application program in the computer memory;
a EJB multiple data source connector program in the memory operable to, receive a data query, connect to a data source, issue the query to the connected data source, receive a response as an EJB object from the connected data source, bind the EJB object to the JNDI name of the data source, repeat the steps of issuing the query, receiving the response EJB object and binding the response EJB object for another data source, and return the results to the query initiator.

9. The apparatus of claim 8 wherein the data query comes from an application running on a J2EE computer platform.

10. The apparatus of claim 9 wherein the query and target data sources are listed in an XML intent file created by the application.

11. The apparatus of claim 8 wherein the data sources are listed in a default data source file.

12. The apparatus of claim 8 wherein the request is to create a new EJB object.

13. The apparatus of claim 8 wherein the request is to update the binding between an existing EJB object and a data source.

14. The apparatus of claim 8 wherein the request is to delete the binding between an existing EJB object and a data source.

15. A computer readable memory containing a plurality of instructions to cause a computer to connect an EJB CMP bean to multiple data sources, the plurality of instructions comprising:
a first instruction to receive a data query;
a second instruction to connect to a data source;
a third instruction to issue the query to the connected data source;
a fourth instruction to receive a response as an EJB object from the connected data source;
a fifth instruction bind the EJB bean to the JNDI name of the data source;
a sixth instruction to repeat the steps of issuing the query, receiving the response EJB object and binding the response EJB object for another data source; and
a seventh instruction to return the results saved in the results file to the query initiator.

16. The computer readable memory of claim 15 wherein the data query comes from an application running on a J2EE computer platform.

17. The computer readable memory of claim 16 wherein the query and target data sources are listed in an XML intent file created by the application.

18. The computer readable memory of claim 15 wherein the data sources are listed in a default data source file.

19. The computer readable memory of claim 15 wherein the request is to create a new EJB object.

20. The computer readable memory of claim 15 wherein the request is to either update or delete the binding between an existing EJB object and a data source.
